(19) United States
(12) Patent Application Publication
(10) Pub. No.: US 2024/0429014 A1
(43) Pub. Date: Dec. 26, 2024

(54) ULTRA-THIN WELDABLE FUSE

(71) Applicant: Littelfuse, Inc., Chicago, IL (US)

(72) Inventors: Maria Lily Espenilla Rosios, Batangas (PH); Werner Johler, Pfaeffikon (CH); Albert V. Enriquez, Batangas (PH); Arnel Alibuyog Ramos, Laguna (PH)

(73) Assignee: Littelfuse, Inc., Chicago, IL (US)

(21) Appl. No.: 18/741,960

(22) Filed: Jun. 13, 2024

Related U.S. Application Data
(60) Provisional application No. 63/521,913, filed on Jun. 20, 2023.

(51) Int. Cl. H01H 85/17; H01H 85/06; H01H 85/20

(52) U.S. Cl. CPC H01H 85/17; H01H 85/06; H01H 85/2045

(57) ABSTRACT

Disclosed are various protection devices and associated methods. In some embodiments, a protection device may include a substrate, and a fusible element extending between a first terminal and a second terminal, wherein the fusible element, the first terminal, and the second terminal are coupled to the substrate. The protection device may further include a cover formed over the fusible element, wherein the fusible element is positioned between the cover and the substrate.

### CROSS-REFERENCE TO RELATED APPLICATION

This application claims priority to pending U.S. Provisional Patent Application No. 63/521,913, filed Jun. 20, 2023, entitled “Ultra-Thin Weldable Fuse,” which is incorporated by reference herein in its entirety.

### FIELD OF THE DISCLOSURE

The present disclosure is generally related to the field of protection devices. More particularly, embodiments of the present disclosure relate to an ultra-thin weldable fuse.

### BACKGROUND OF THE DISCLOSURE

Fuses are typically used as circuit protection devices and form an electrical connection with a component in a circuit to be protected. A pair of conductors or terminals are often connected via a fusible element that forms a bridge between the terminals. Some fuses take up too much space, however.

Accordingly, there is a need for a thin fuse applicable for battery protection, wherein the desired electrical performance is still maintained.

### SUMMARY OF THE DISCLOSURE

The Summary is provided to introduce a selection of concepts in a simplified form, the concepts further described below in the Detailed Description. The Summary is not intended to identify key features or essential features of the claimed subject matter, nor is the Summary intended as an aid in determining the scope of the claimed subject matter.

In one approach, a protection device may include a substrate, and a fusible element extending between a first terminal and a second terminal, wherein the fusible element, the first terminal, and the second terminal are coupled to the substrate. The protection device may further include a cover formed over the fusible element, wherein the fusible element is positioned between the cover and the substrate.

In another approach, a method of forming a protection device may include coupling a fusible element to a substrate, wherein the fusible element extends between a first terminal and a second terminal, and forming a cover over the fusible element, wherein the fusible element is positioned between the cover and the substrate.

In yet another approach, a fusible device may include a substrate, and a fusible element extending between a first terminal and a second terminal, wherein the fusible element, the first terminal, and the second terminal are coupled to the substrate. The fusible device may further include a cover formed over the fusible element, wherein the fusible element is positioned between the cover and the substrate, and wherein the cover is partially formed over the first terminal and the second terminal.

### BRIEF DESCRIPTION OF THE DRAWINGS

The accompanying drawings illustrate exemplary approaches of the disclosed embodiments so far devised for the practical application of the principles thereof, and wherein:

FIG. 1 depicts a perspective view of a protection device according to embodiments of the present disclosure;

FIG. 2 depicts a perspective exploded view of the protection device of FIG. 1, according to embodiments of the present disclosure;

FIG. 3 depicts another perspective view of the protection device of FIG. 1, according to embodiments of the present disclosure;

FIG. 4 depicts a perspective view of a protection device according to embodiments of the present disclosure;

FIG. 5 depicts a perspective exploded view of the protection device of FIG. 4, according to embodiments of the present disclosure;

FIG. 6 depicts another perspective view of the protection device of FIG. 4, according to embodiments of the present disclosure;

FIGS. 7-8 depict perspective views of the protection device of FIG. 4 including a plurality of plating layers, according to embodiments of the present disclosure;

FIG. 9 depicts a flowchart of a method of forming the protection device of FIGS. 1-3, according to embodiments of the present disclosure;

FIG. 10 depicts a flowchart of a method of forming the protection device of FIGS. 4-8, according to embodiments of the present disclosure;

FIGS. 11-12 depict perspective views of a protection device according to embodiments of the present disclosure; and

FIG. 13 depicts a perspective exploded view of the protection device of FIGS. 11-12, according to embodiments of the present disclosure.

The drawings are not necessarily to scale. The drawings are merely representations, not intended to portray specific parameters of the disclosure. The drawings are intended to depict exemplary embodiments of the disclosure, and therefore are not to be considered as limiting in scope. In the drawings, like numbering represents like elements.

Furthermore, certain elements in some of the figures may be omitted, or illustrated not-to-scale, for illustrative clarity. The cross-sectional views may be in the form of “slices”, or “near-sighted” cross-sectional views, omitting certain background lines otherwise visible in a “true” cross-sectional view, for illustrative clarity. Furthermore, for clarity, some reference numbers may be omitted in certain drawings.

### DETAILED DESCRIPTION

Protection devices, fuse assemblies, and methods in accordance with the present disclosure will now be described more fully hereinafter with reference to the accompanying drawings, where embodiments are shown. The protection devices, fuse assemblies, and methods may be embodied in many different forms and are not to be construed as being limited to the embodiments set forth herein. Instead, these embodiments are provided so the disclosure will be thorough and complete, and will fully convey the scope of the disclosure to those skilled in the art.

Embodiments of the present disclosure provide an ultrathin weldable solution for battery protection application using a flexible polyimide substrate material. The fuse is flexible and achieves an ultra-thin profile of less than approximately 0.4 mm. Electrical performance may be optimized by modifying the fusible element pattern, which extends between terminals. In some examples, a polyamide (PI) quad may be used as a substrate, wherein the element may be formed via photolithography and chemical etching, and then covered with a liquid photo-imageable mask (LPI) material. The terminals may be weldable and may be achieved by exposing the Cu on the terminations via laser stripping of the polyimide layer.

In another example, instead of laser stripping the Cu termination, PCB rivets may be installed to provide electrical connection and to mechanically fasten to Cu strips, which will then act as the weldable leads and extended fuse termination. Tin (Sn) plated fuse termination may optionally be provided for additional metallic connection, wherein the plating may be formed by dipping.

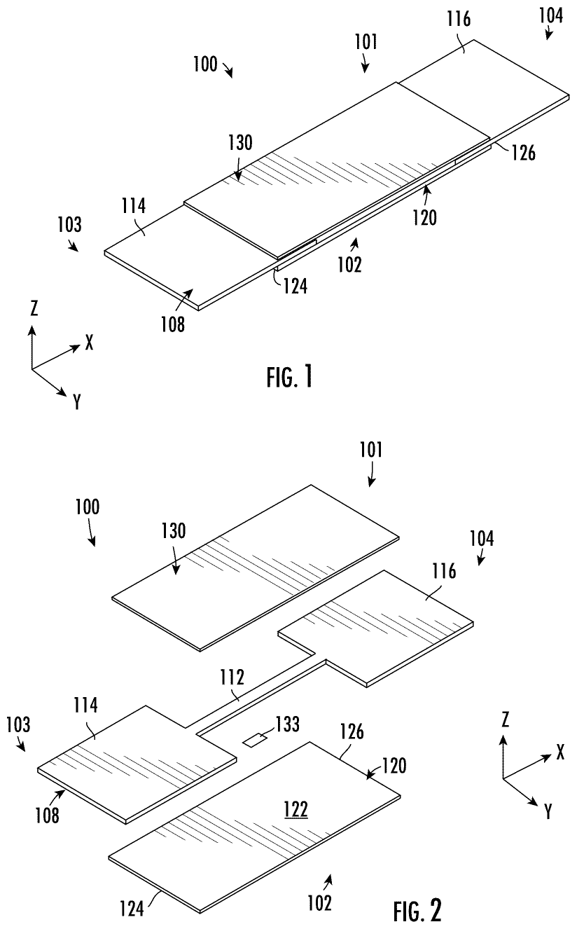

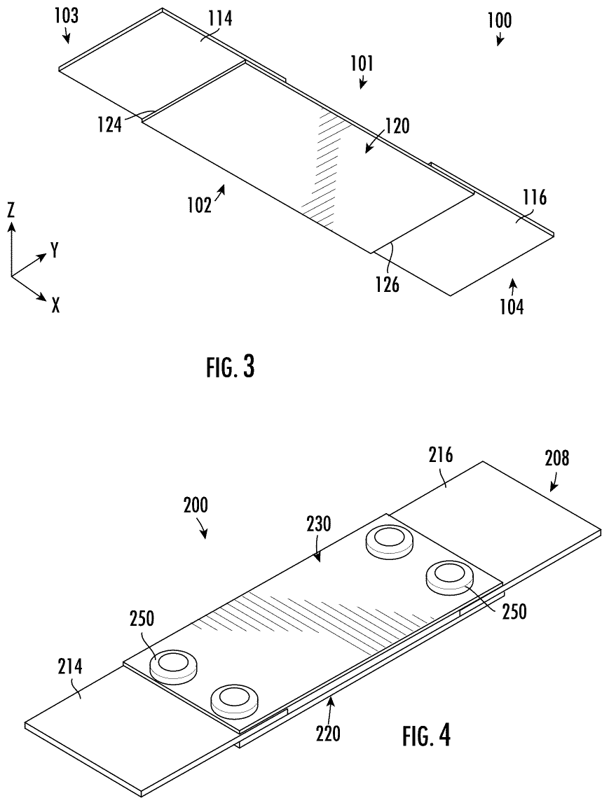

FIGS. 1-3, depict a protection device (hereinafter “device”) 100 according to embodiments of the present disclosure. As shown, the device 100 may include a first main side 101 opposite a second main side 102, and a first end 103 opposite a second end 104. The device 100 may include a metal layer 108 (e.g., copper) formed into a fusible element 112, a first terminal 114, and a second terminal 116. It will be appreciated that the fusible element 112 is not limited to any particular shape or configuration. For example, although shown and described herein as being straight, or substantially straight, the fusible element 112 may also be curved, sloped, or bent. More than one fusible element 112 may also be present. Embodiments herein are not limited in this context.

In accordance with known electrical fuses, the fusible element 112 is constructed to melt, vaporize, disintegrate or otherwise structurally fail when a predetermined magnitude of electrical current flows through the fuse for a duration of time, sometimes referred to as an overcurrent condition, that may damage sensitive electronic components. That is, the current path through the device 100 is designed to fail and open the current path through the fusible element 112 to avoid damage to sensitive circuit components. The amount of current that the fusible element 112 may sustain before opening the current path may vary depending on its particular material properties and dimensional aspects. Various fuse link or fuse element constructions are known for such a purpose. Once the fusible element 112 is opened, the fuse assembly may be replaced to restore the electrical circuitry to full operation.

Device 100 may further include a substrate 120, wherein the metal layer 108 is coupled to an upper surface 122 of the substrate 120. In some embodiments, the first terminal 114 may extend beyond a first and 124 of the substrate 120, and the second terminal 116 may extend beyond a second end 126 of the substrate 120. The substrate 120 may be a polyamide substrate.

As further shown, the device 100 may include a cover 130 extending over the fusible element 112. Said another way, the metal layer 108 may be sandwiched by the substrate 120 and the cover 130. As shown, the cover 130 may further extend over the first terminal 114 and the second terminal 116. Although non-limiting, the cover 130 may have similar dimensions (e.g., in the x-direction and the y-direction) to the substrate 120. In some embodiments, the cover 130 may be a liquid photo-imageable mask, silicone, and/or other polymers. Once assembled, the device 100 may have a thickness (in the z-direction) of less than 0.4 mm. An approach for forming the device 100 will be further described below.

In some embodiments, the device 100 may further include a metal element 133, which may be a Metcalf effect (M-effect) coating of Sn applied to one or more surfaces of the fusible element 112. During overload heating, the Sn of the metal element 133 and the Cu of the fusible element 112 diffuse together in an attempt to form a eutectic material, resulting in a lower melting temperature in the area of the metal element 133.

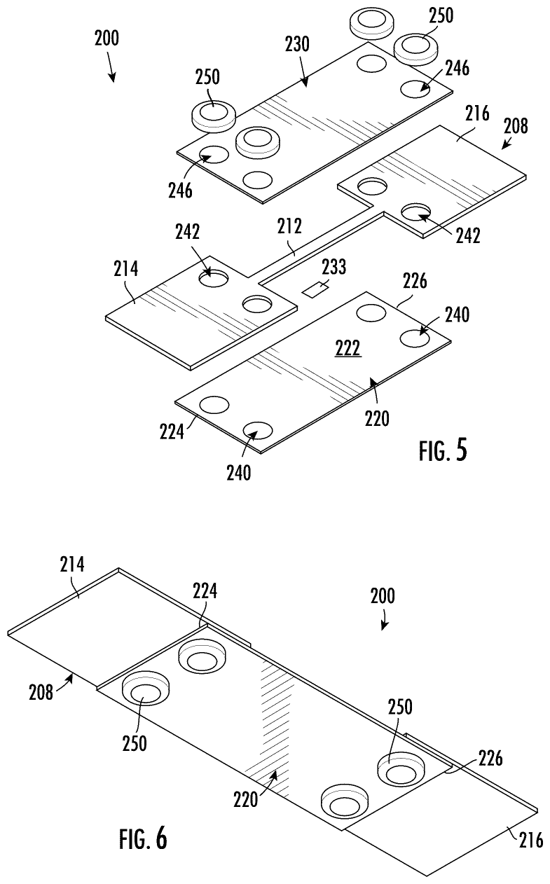

FIGS. 4-6, depict another protection device (hereinafter “device”) 200 according to embodiments of the present disclosure. As shown, the device 200 may include a metal layer 208 (e.g., copper) formed into a fusible element 212, a first terminal 214, and a second terminal 216. It will be appreciated that the fusible element 212 is not limited to any particular shape or configuration. For example, although shown and described herein as being straight, or substantially straight, the fusible element 212 may also be curved, sloped, or bent. More than one fusible element 212 may also be present. Embodiments herein are not limited in this context.

Device 200 may further include a substrate 220, wherein the metal layer 208 is coupled to an upper surface 222 of the substrate 220. In some embodiments, the first terminal 214 may extend beyond a first end 224 of the substrate 220, and the second terminal 216 may extend beyond a second end 226 of the substrate 220. The substrate 220 may be a polyamide substrate.

As further shown, the device 200 may include a cover 230 extending over the fusible element 212, wherein the metal layer 208 may be sandwiched by the substrate 220 and the cover 230. In some embodiments, the cover 230 may further extend over the first terminal 214 and the second terminal 216. Although non-limiting, the cover 230 may have similar dimensions (e.g., in the x-direction and the y-direction) to the substrate 220. In some embodiments, the cover 230 may be a liquid photo-imageable mask.

In some embodiments, the device 200 may further include a metal element 233, which may be a Metcalf effect (M-effect) coating of Sn applied to one or more surfaces of the fusible element 212.

As best shown in FIG. 5, the substrate 220 may include a first plurality of openings 240, the metal layer 208 may include a second plurality of openings 242, and the cover 230 may include a third plurality of openings 246. One or more fasteners 250 (e.g., rivets) may be formed through each of the openings to secure the layers of the device 200 together. The fasteners 250 may further provide an electrical connection with the first and second terminals 214, 216. An approach for forming the device 200 will be further described below.

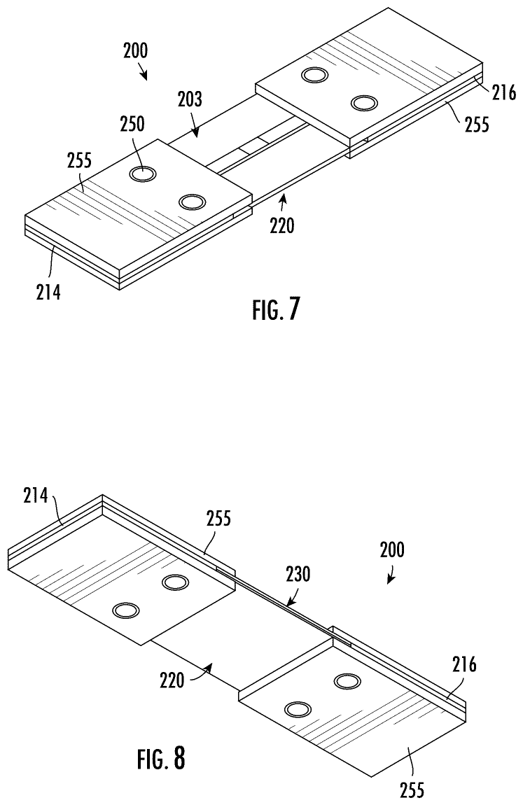

As shown in FIGS. 7-8, in some embodiments, the device 200 (and/or the device 100) may include one or more plating layers 255 formed on opposite sides of the cover 230 and the substrate 220. The plating layers 255 provide an additional metallic connection, and may also be secured by the fasteners 250. Plating layers 255 may be electrically and physically connected with the first terminal 214 and the second terminal 216 of the metal layer 208. In some embodiments, the plating layers 255 may be Ni and Sn and/or Sn.

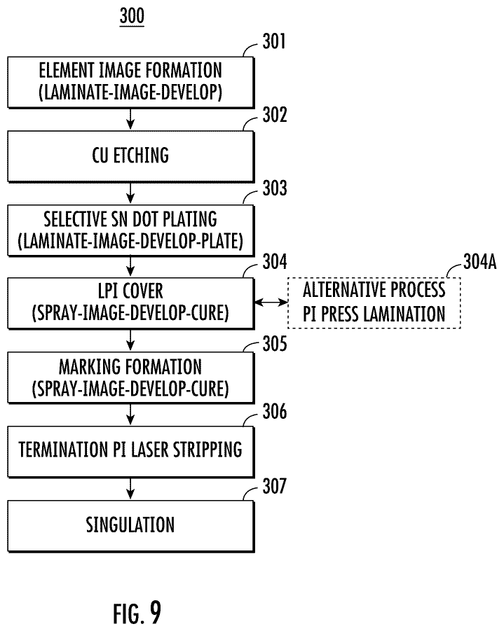

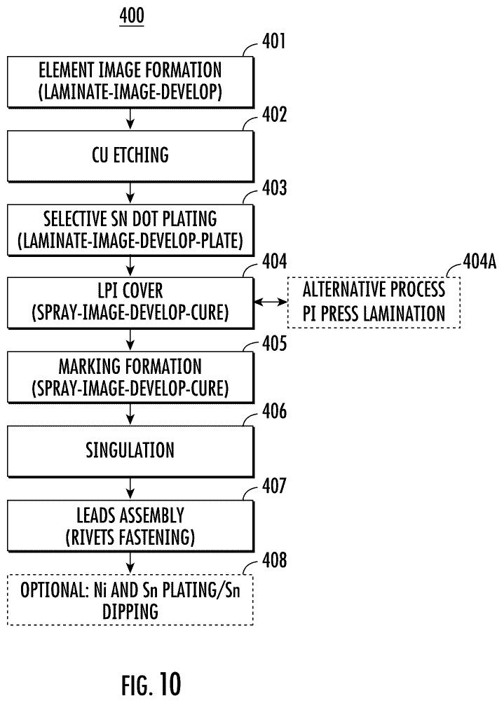

Turning now to FIG. 9, a method 300 for forming the device 100 will be described in greater detail. At block 301, the method 300 may include preparing the fusible element 112. In some embodiments, the fusible element 112 is prepared using a laminating, imaging, and developing processes.

At block 302, the method 300 may include etching a layer of copper 108 to form the fusible element 112, based on the preparation process.

At block 303, the method 300 may include performing a selective SN dot plating process to form the metal element 133, and at block 304 method 300 may include forming the cover 130 over the fusible element 112. In some embodiments the cover 130 may be an LPI cover formed using a spraying, imaging, developing, and then curing processes.

Alternatively, at block 304A, the method 300 may include forming the cover 130 using a polyamide press lamination process.

At block 305, the method 300 may include a marking formation process, which may include a series of spray, image, develop, and cure steps.

At block 306, the method 300 may include removing a portion of the cover 130 from over the first terminal 114 and the second terminal 116. In some embodiments, the cover 130 is removed using a polyamide laser stripping process.

At block 307, the method 300 may include performing a singulation process.

Turning now to FIG. 10, a method 400 for forming the device 200 will be described in greater detail. At block 401, the method 400 may include preparing the fusible element 212. In some embodiments, the fusible element 212 is prepared using a laminate, imaging, and developing process.

At block 402, the method 400 may include etching the layer of copper 208 to form the fusible element 212, followed by performing a selective SN dot plating process to form the metal element 233 at block 403.

At block 404, method 400 may include forming the cover 230 over the fusible element 212, wherein the cover 230 may be an LPI cover formed using a spray, image, develop, and then cure process. Alternatively, at block 404A, the method 400 may include forming the cover 230 using a polyamide press lamination process.

At block 405, the method 400 may include a marking formation process, which may include a series of spray, image, develop, and cure steps.

At block 406, a singulation process may be performed, followed by a lead assembly process at block 407. In some embodiments, the plurality of rivets 250 are formed through the various layers of the device 200.

At block 408, an optional plating process may be performed. The plating layers may be Ni and Sn and/or Sn, which is formed over the first terminal 214 and over the second terminal 216.

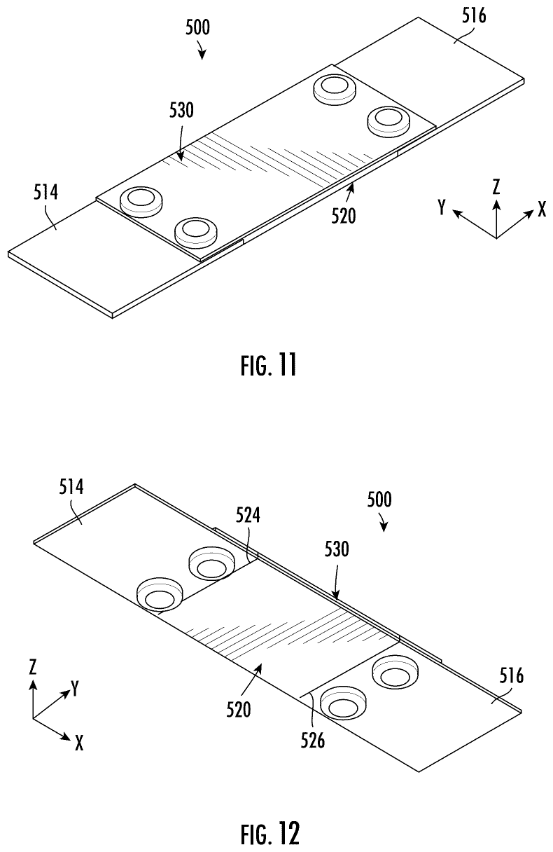

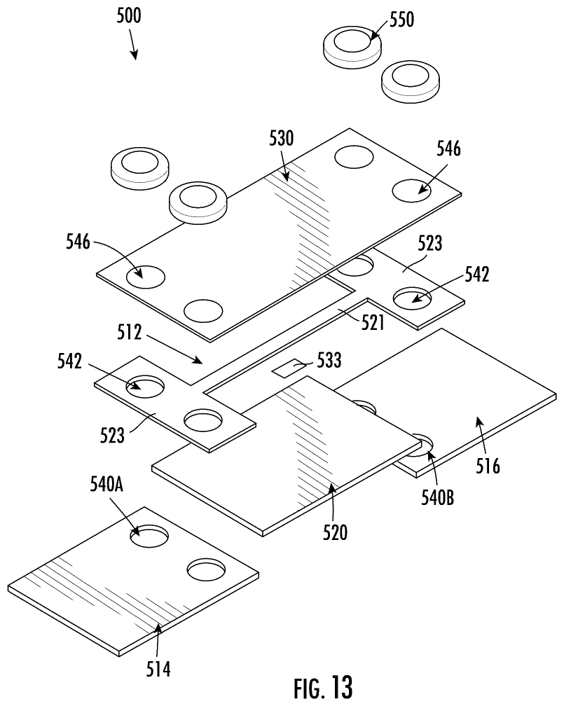

FIGS. 11-13, depict another protection device (hereinafter “device”) 500 according to embodiments of the present disclosure. The device 500 may the same or similar in some aspects to the other devices described herein. As such, only certain aspects of the device 500 will hereinafter be described for the sake of brevity. As shown, the device 500 may a fusible element 512, a first terminal (or lead) 514, and a second terminal (or lead) 516. As best shown in FIG. 13, the fusible element 512 may include a thinned, central section 521 extending between a first flange 523 and a second flange 525. Other shapes and configurations are possible in alternative embodiments.

Device 500 may further include a substrate 520, wherein the fusible element 512 is coupled to an upper surface of the substrate 520. In some embodiments, the first terminal 514 may abut a first end 537 of the substrate 520 and a second end 526 of the substrate 520. In the embodiment shown, the substrate 520 may be a polyamide substrate.

As further shown, the device 500 may include a cover 530 extending over the fusible element 512, wherein the fusible element 512 may be sandwiched by the substrate 520 and the cover 530. In some embodiments, the cover 530 may further extend over the first terminal 514 and the second terminal 516. Although non-limiting, the cover 530 may be larger (e.g., in the x-direction) than the substrate 520. In some embodiments, the cover 530 may be a liquid photo-imageable mask.

As best shown in FIG. 13, the device 200 may further include a metal element 533, which may be a Metcalf effect (M-effect) coating of Sn applied to one or more surfaces of the fusible element 512. As further shown, the first terminal 514 may include a first plurality of openings 540A, the second terminal 516 may include a second plurality of openings 540B, the fusible element 512 may include a third plurality of openings 542, and the cover 530 may include a fourth plurality of openings 546. One or more fasteners 550 (e.g., rivets) may be formed through each of the openings to secure the layers of the device 500 together. The fasteners 550 may further provide an electrical connection with the first and second terminals 514, 516.

As used herein, an element or step recited in the singular and proceeded with the word “a” or “an” is understood as not excluding plural elements or steps, unless such exclusion is explicitly recited. Furthermore, references to “one embodiment” of the present disclosure are not intended to be interpreted as excluding the existence of additional embodiments also incorporating the recited features.

The use of “including,” “comprising,” or “having” and variations thereof herein is meant to encompass the items listed thereafter and equivalents thereof as well as additional items. Accordingly, the terms “including,” “comprising,” or “having” and variations thereof are open-ended expressions and can be used interchangeably herein.

The phrases “at least one”, “one or more”, and “and/or”, as used herein, are open-ended expressions and are both conjunctive and disjunctive in operation. For example, expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

All directional references (e.g., proximal, distal, upper, lower, upward, downward, left, right, lateral, longitudinal, front, back, top, bottom, above, below, vertical, horizontal, radial, axial, clockwise, and counterclockwise) are just used for identification purposes to aid the reader's understanding of the present disclosure. The directional references do not create limitations, particularly as to the position, orientation, or use of the disclosure. Connection references (e.g., attached, coupled, connected, and joined) are to be construed broadly and may include intermediate members between a collection of elements and relative movement between elements unless otherwise indicated. As such, connection references do not necessarily infer two elements are directly connected and in fixed relation to each other.

Furthermore, identification references (e.g., primary, secondary, first, second, third, fourth, etc.) are not intended to connote importance or priority, and are used to distinguish one feature from another. The drawings are for purposes of illustration, and the dimensions, positions, order and relative sizes reflected in the drawings attached hereto may vary.

Furthermore, the terms “substantial” or “approximately,” as well as the terms “approximate” or “approximately,” can be used interchangeably in some embodiments, and can be described using any relative measures acceptable by one of ordinary skill in the art. For example, these terms can serve as a comparison to a reference parameter, to indicate a deviation capable of providing the intended function. Although non-limiting, the deviation from the reference parameter can be, for example, in an amount of less than 1%, less than 3%, less than 5%, less than 10%, less than 15%, less than 20%, and so on.

While certain embodiments of the disclosure have been described herein, the disclosure is not limited thereto, as the disclosure is as broad in scope as the art will allow and the specification may be read likewise. Therefore, the above description is not to be construed as limiting. Instead, the above description is merely as exemplifications of particular embodiments. Those skilled in the art will envision other modifications within the scope and spirit of the claims appended hereto.

What is claimed is:

1. A protection device, comprising:
a substrate;
a fusible element extending between a first terminal and a second terminal, wherein the fusible element, the first terminal, and the second terminal are coupled to the substrate; and
a cover formed over the fusible element, wherein the fusible element is positioned between the cover and the substrate.

2. The protection device of claim 1, wherein the cover is partially formed over the first terminal and the second terminal.

3. The protection device of claim 1, wherein the cover is a liquid photo-imageable mask, a silicone mask, or a polymer mask.

4. The protection device of claim 1, wherein the substrate is a polyimide substrate.

5. The protection device of claim 1, further comprising a plurality of fasteners coupling together the cover, the substrate, and the fusible element.

6. The protection device of claim 1, further comprising a plating layer formed over the first and second terminals.

7. The protection device of claim 1, further comprising a layer of tin formed on the fusible element.

8. A method of forming a protection device, comprising:
coupling a fusible element to a substrate, wherein the fusible element extends between a first terminal and a second terminal; and
forming a cover over the fusible element, wherein the fusible element is positioned between the cover and the substrate.

9. The method of claim 8, further comprising partially forming the cover over the first terminal and the second terminal.

10. The method of claim 8, wherein the cover is a liquid photo-imageable mask.

11. The method of claim 8, wherein the substrate is a polyimide substrate.

12. The method of claim 8, further comprising coupling together, using a plurality of fasteners, the cover, the substrate, and the fusible element.

13. The method of claim 12, wherein the plurality fasteners are rivets.

14. The method of claim 8, further comprising forming a plating layer over the first and second terminals.

15. The method of claim 14, wherein the plating layer is formed by dipping the first terminal and the second terminal in tin.

16. The method of claim 8, further comprising partially removing the cover to expose the first terminal and the second terminal.

17. The method of claim 16, wherein the cover is removed using a laser stripping process.

18. A fusible device, comprising:
a substrate;
a fusible element extending between a first terminal and a second terminal, wherein the fusible element, the first terminal, and the second terminal are coupled to the substrate; and
a cover formed over the fusible element, wherein the fusible element is positioned between the cover and the substrate, and wherein the cover is partially formed over the first terminal and the second terminal.

19. The fusible device of claim 18, wherein the cover is a liquid photo-imageable mask, a silicone mask, or a polymer mask.

20. The fusible device of claim 18, further comprising a plating layer formed over the first and second terminals.
